(19) United States
(12) Patent Application Publication
(10) Pub. No.: US 2025/0116054 A1
(43) Pub. Date: Apr. 10, 2025

(54) WASHING MACHINE

(71) Applicant: SAMSUNG ELECTRONICS CO., LTD., Suwon-si (KR)

(72) Inventors: Hwangmook CHO, Suwon-si (KR); Changnyeun KIM, Suwon-si (KR); Sungho YOON, Suwon-si (KR); Jeongyun LEE, Suwon-si (KR); Hongkwon CHUN, Suwon-si (KR)

(73) Assignee: SAMSUNG ELECTRONICS CO., LTD., Suwon-si (KR)

(21) Appl. No.: 18/830,038

(22) Filed: Sep. 10, 2024

Related U.S. Application Data
(63) Continuation of application No. PCT/KR2024/012741, filed on Aug. 27, 2024.

(30) Foreign Application Priority Data
Oct. 5, 2023 (KR) 10-2023-0132888
Dec. 11, 2023 (KR) 10-2023-0179133

(51) Int. Cl. D06F 43/02; D06F 43/08

(52) U.S. Cl. CPC D06F 43/02; D06F 43/081

(57) ABSTRACT

A washing machine may include a storage tank to store carbon dioxide; a tub to wash laundry using the carbon dioxide; a distillation tub to separate carbon dioxide discharged from the tub and foreign substances contained in the carbon dioxide; a compressor to compress the carbon dioxide discharged from the tub and move the carbon dioxide to the storage tank; a rotatable drum inside the tub; a driving device to drive rotation of a rotatable shaft connected to the rotatable drum to rotate the rotatable drum; a pipe configured to pass inside of the tub to exchange heat of the compressed carbon dioxide with the tub; and a blade protruding from the rotatable shaft so that the blade is rotated by rotation of the rotatable shaft to circulate air inside the tub to spread the heat of the compressed carbon dioxide emitted from the pipe.

### CROSS-REFERENCE TO RELATED APPLICATIONS

This is a continuation application, under 35 U.S.C. § 111(a), of International Application PCT/KR2024/012741, filed Aug. 27, 2024, which claims priority under 35 U.S.C. § 119 to Korean Patent Application No. 10-2023-0132888, filed Oct. 5, 2023 and Korean Patent Application No. 10-2023-0179133, filed Dec. 11, 2023, in the Korean Intellectual Property Office, the disclosures of which are incorporated herein in their entireties by reference.

### TECHNICAL FIELD

The present disclosure relates to a washing machine.

### BACKGROUND ART

In general, a washing machine is an apparatus that washes laundry using water as a washing solvent. On the other hand, there is a dry-cleaning washing machine that washes laundry without using water by using a washing solvent that is a volatile organic compound rather than water. A solvent-based or petroleum-based washing solvent may be used in a dry-cleaning washing machine.

A washing machine using water may pollute an environment by generating wastewater in a washing process, and the solvent-based washing solvent and petroleum-based washing solvent used in a dry-cleaning washing machines are harmful to a human body and may pollute an environment.

Carbon dioxide may be used as a washing solvent in place of the above washing solvents. Carbon dioxide has a lower viscosity than water and thus may easily penetrate between fibers to remove contaminants. As carbon dioxide containing foreign substances is vaporized after washing, the carbon dioxide and foreign substances may be separated, and the vaporized carbon dioxide may be reused.

Carbon dioxide is one of components of a general atmosphere and thus does not pollute the environment, and is reused by vaporizing and liquefying liquid carbon dioxide and thus may also contribute to achieving carbon neutrality as carbon dioxide emissions are not large.

### DISCLOSURE

### Technical Problem

The present disclosure is directed to providing a washing machine capable of preventing damage to laundry by preventing a rapid drop in temperature inside a washing tub when a pressure of the washing tub is reduced.

Technical tasks to be achieved in this document are not limited to the technical tasks mentioned above, and other technical tasks not mentioned will be clearly understood by those skilled in the art to which the present invention belongs from the description below.

### Technical Solution

An aspect of the present disclosure includes a washing machine including a storage tank configured to store carbon dioxide; a washing tub configured to wash laundry using the carbon dioxide; a distillation tub configured to separate the carbon dioxide discharged from the washing tub and foreign substances contained in the carbon dioxide; a compressor configured to compress the carbon dioxide discharged from the washing tub and move the compressed carbon dioxide to the storage tank; a rotatable drum inside the washing tub; a driving device configured to drive rotation of a rotatable shaft connected to the rotatable drum to rotate the rotatable drum; a washing tub passing pipe configured to pass through an inside of the washing tub to exchange heat of the compressed carbon dioxide with the washing tub; and a blade protruding radially from the rotatable shaft so that the blade rotated by rotation of the rotatable shaft to circulate air inside the washing tub to spread the heat of the compressed carbon dioxide emitted from the washing tub passing pipe.

At least a portion of the blade may correspond to the washing tub passing pipe along an inside of the washing tub to facilitate heat exchange between the washing tub and the washing tub passing pipe.

The washing tub passing pipe may include: an inlet pipe connected to a flow path extending from the compressor, an outlet pipe connected to the storage tank, and a heat exchange pipe connected to the inlet pipe and the outlet pipe and extending in a coil shape a distance from an inner circumferential surface of the washing tub.

At least a portion of the blade may extend farther from a rear surface of the rotatable drum than the heat exchange pipe so that at least the portion of the blade may be farther from the rear surface than an end of the heat exchange pipe which is connected to the inlet pipe or the outlet pipe.

The blade may include a wing part, and a connecting rib, protruding from a rear surface of the rotatable drum, and connected to the wing part.

A length of the connecting rib extending in a direction perpendicular to the rotatable shaft may be longer than a length of the wing part extending in the direction perpendicular to the rotatable shaft.

The blade may include a concave surface and a convex surface on an opposite side of the blade from the concave surface.

The washing machine may further include: a controller configured to control rotation of the driving device, and the controller may be configured to control the driving device to rotate the blade when carbon dioxide is discharged from the washing tub to the compressor.

The washing machine may further include: a washing tub temperature sensor configured to measure a temperature inside the washing tub, and the controller may be configured to control the driving device to rotate the blade when the temperature inside the washing tub detected by the washing tub temperature sensor is equal to or lower than a first temperature.

The washing tub passing pipe further includes a first connecting pipe in a bent shape to connect the inlet pipe and the heat exchange pipe, and a second connecting pipe in a bent shape to connect the outlet pipe and the heat exchange pipe.

The rotatable drum may include a plurality of passing holes at a rear surface of the rotatable drum.

A rotation radius of the wing part from the rotatable shaft may be smaller than an inner radius of the heat exchange pipe from the rotatable shaft so as to prevent collision between the wing part and the heat exchange pipe when the blade is rotated by the rotatable shaft.

A thickness of the connecting rib may be greater than a thickness of the wing part.

Another aspect of the present disclosure provides a washing machine including a storage tank provided to store carbon dioxide, a washing tub provided to wash laundry using the carbon dioxide, a distillation tub provided to separate the carbon dioxide discharged from the washing tub and foreign substances contained in the carbon dioxide, a compressor provided to compress and move the carbon dioxide discharged from at least one of the washing tub and the distillation tub, a drum rotatably provided inside the washing tub, a driving device provided to rotationally drive the drum around a rotating shaft, an inlet pipe connected to a flow path extending from the compressor, an outlet pipe connected to the storage tank, a washing tub passing pipe including a heat exchange pipe connected to the inlet pipe and the outlet pipe and extending in a coil shape at a predetermined distance from an inner circumferential surface of the washing tub, and a blade provided to protrude radially from the rotating shaft to rotate by receiving power from the driving device, the blade being disposed such that at least a portion of the blade corresponds to the washing tub passing pipe inside the washing tub to circulate heat inside the washing tub and including a curved shape with a concave surface and a convex surface formed on an opposite side of the concave surface.

### DESCRIPTION OF DRAWINGS

FIG. 1 is a conceptual diagram for explaining a flow of carbon dioxide in a washing machine according to an embodiment of the present disclosure.

FIG. 2 is a conceptual diagram for explaining a process of recovering carbon dioxide inside a distillation tub to a storage tank in the washing machine according to an embodiment of the present disclosure.

FIG. 3 is a conceptual diagram for explaining a process of recovering carbon dioxide inside a washing tub to the storage tank in the washing machine according to an embodiment of the present disclosure.

FIG. 4 is an enlarged partial cross-sectional view illustrating the inside of the washing tub in the washing machine according to an embodiment of the present disclosure.

FIG. 5 is a perspective view illustrating a part of the washing machine including a blade according to an embodiment of the present disclosure.

FIG. 6 is a perspective view illustrating a part of the washing machine including the blade according to an embodiment of the present disclosure.

FIG. 7 is a perspective view illustrating a part of the washing machine including the blade according to an embodiment of the present disclosure.

FIG. 8 is a perspective view illustrating a part of the washing machine including the blade according to an embodiment of the present disclosure.

FIG. 9 is a perspective view illustrating a part of the washing machine including the blade according to an embodiment of the present disclosure.

### MODE OF THE DISCLOSURE

Various embodiments and terms in this document are not intended to limit the technical features described in this document to specific embodiments, and should be understood to include various modifications, equivalents, or substitutes of the embodiments.

In connection with the description of the drawings, like reference numbers may be used for like or related components.

The singular form of a noun corresponding to an item may include one item or a plurality of items, unless the relevant context clearly dictates otherwise.

In this document, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms such as “first” and “second,” or “primary” and “secondary” may simply be used to distinguish a given component from other corresponding components, and do not limit the corresponding components in any other aspect (e.g., importance or order).

When any (e.g., first) component is referred to as being “coupled” or “connected” to another (e.g., second) component with or without the term “functionally” or “communicatively”, this means that the any component may be connected to the other component directly (e.g., by wire), wirelessly, or through a third component.

The terms “comprises” and “has” are intended to indicate that there are features, numbers, steps, operations, components, parts, or combinations thereof described in this document, and do not exclude the presence or addition of one or more other features, numbers, steps, operations, components, parts, or combinations thereof.

When any component is referred to as being “connected”, “coupled”, “supported” or “in contact” with another component, this includes a case in which the components are indirectly connected, coupled, supported, or in contact with each other through a third component as well as directly connected, coupled, supported, or in contact with each other.

When any component is referred to as being located “on” or “over” another component, this includes not only a case in which any component is in contact with another component but also a case in which another component is present between the two components.

A washing machine according to various embodiments may include a housing for accommodating various components therein. The housing may be provided in the form of a box with a laundry inlet formed on one side thereof.

The washing machine may include a door for opening and closing the laundry inlet. The door may be rotatably mounted on the housing by a hinge. At least a portion of the door may be provided to be transparent or translucent so that the inside of the housing is visible.

The washing machine may include a drum provided to accommodate laundry.

The drum may perform each operation according to washing and rinsing procedures while rotating inside the housing. A number of apertures may be formed on a cylindrical wall of the drum.

The washing machine may include a driving device configured to rotate the drum. The driving device may include a driving motor and a rotating shaft for transmitting a driving force generated by the driving motor to the drum.

The driving device may perform each operation according to the washing and rinsing procedures by rotating the drum forward or backward.

The washing machine may include a control panel disposed on one surface of the housing. The control panel may provide a user interface for interaction between a user and the washing machine. The user interface may include at least one input interface and at least one output interface.

The at least one input interface may convert sensory information received from the user into an electrical signal.

The at least one input interface may include a power button, an operation button, a course selection dial (or course selection button), and a wash/rinse button. The at least one input interface may include, for example, a tact switch, a push switch, a slide switch, a toggle switch, a micro switch, a touch switch, a touch pad, a touch screen, a jog dial, and/or a microphone, etc.

The at least one output interface may visually or audibly transmit information related to the operation of the washing machine to the user.

For example, the at least one output interface may transmit information related to a washing course, an operating time of the washing machine, and wash setting/rinse setting to the user. Information about the operation of the washing machine may be output through a screen, indicator, voice, etc. The at least one output interface may include, for example, a liquid crystal display (LCD) panel, a light emitting diode (LED) panel, a speaker, etc.

The washing machine may include a communication module for communicating with an external device via wired and/or wireless.

The communication module may include at least one of a short-range communication module or a long-distance communication module.

The communication module may transmit data to or receive data from an external device (e.g., server, user device, and/or home appliance). For example, the communication module may establish communication with a server and/or a user device and/or a home appliance, and transmit and receive various data.

To this end, the communication module may support establishment of a direct (e.g., wired) communication channel or wireless communication channel between external devices, and performance of communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module or a power line communication module). A corresponding communication module of these communication modules may communicate with an external device through a first network (e.g., a short-range communication network such as Bluetooth, wireless fidelity (Wi-Fi) direct, and infrared data association (IrDA)) or a second network (e.g., a long-distance communication network such as a legacy cellular network, 5G network, next-generation communication network, the Internet, and a computer network (e.g., LAN or WAN)). These various types of communication modules may be integrated into one component (e.g., a single chip) or may be implemented as a plurality of separate components (e.g., multiple chips).

The short-range wireless communication module may include, but is not limited thereto, a Bluetooth communication module, Bluetooth low energy (BLE) communication module, Near Field communication module, WLAN (Wi-Fi) communication module, Zigbee communication module, infrared data association (IrDA) communication module, Wi-Fi Direct (WFD) communication module, ultrawideband (UWB) communication module, Ant+ communication module, microwave (uWave) communication module, etc.

The long-distance communication module may include a communication module that performs various types of long-distance communication and may include a mobile communication unit. The mobile communication unit transmits and receives wireless signals to and from at least one of a base station, an external terminal, and a server on a mobile communication network.

In an embodiment, the communication module may communicate with an external device such as a server, a user device, and other home appliances through a nearby access point (AP). The access repeater (AP) may connect a local area network (LAN) to which the washing machine or user device is connected to a wide area network (WAN) to which the server is connected. The washing machine or user device may be connected to the server via the wide area network (WAN). A controller may control various components of the washing machine (e.g., driving motor). The controller may control various components of the washing machine to perform at least one procedure including water supply, washing, rinsing, etc. according to a user input. For example, the controller may control the driving motor to adjust a rotational speed of the drum.

The controller may include hardware such as a CPU and memory, and software such as a control program. For example, the controller may include an algorithm for controlling operations of components in the washing machine, at least one memory for storing data in the form of a program, and at least one processor for performing the above-described operations using data stored in the at least one memory. The memory and processor may each be implemented as a separate chip. The processor may include one or two or more processor chips, or may include one or two or more processing cores. The memory may include one or two or more memory chips, or may include one or two or more memory blocks. The memory and processor may also be implemented as a single chip.

Hereinafter, embodiments according to the present disclosure will be described in detail with reference to the accompanying drawings.

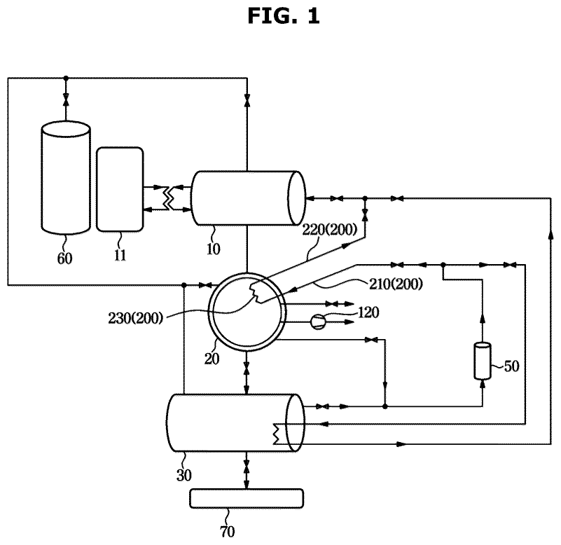

FIG. 1 is a conceptual diagram for explaining a flow of carbon dioxide in a washing machine 1 according to an embodiment of the present disclosure.

Referring to FIG. 1, the washing machine 1 according to an embodiment may include a storage tank 10 provided to store carbon dioxide, a washing tub 20 provided to allow washing to be performed using the carbon dioxide, a distillation tub 30 provided to accommodate the carbon dioxide and foreign substances discharged from the washing tub 20, a foreign substance tank 70 provided to store and discharge the foreign substances discharged from the distillation tub 30, a compressor 50 provided to compress and move the carbon dioxide, and a chiller 11 provided to cool the storage tank 10. The washing machine 1 may further include a replenishing tank 60 provided to replenish carbon dioxide lost in a process of recovering carbon dioxide after washing.

The storage tank 10 may be provided to store carbon dioxide. The storage tank 10 may be provided to store gaseous carbon dioxide and liquid carbon dioxide. The storage tank 10 may maintain an internal pressure thereof at a predetermined pressure or more to be capable of storing liquid carbon dioxide. For example, the internal pressure of the storage tank 10 may be substantially 30 to 70 bar.

The storage tank 10 may include a first outlet provided to allow gaseous carbon dioxide to be discharged, and a second outlet provided to allow liquid carbon dioxide to be discharged. The storage tank 10 may include an inlet through which gaseous carbon dioxide is introduced from the outside. The first outlet may be formed at a higher position than the second outlet so that the liquid carbon dioxide inside the storage tank 10 is not discharged through the first outlet. The inlet may be formed at a higher position than the second outlet so that the liquid carbon dioxide inside the storage tank 10 is not discharged through the inlet. For example, the first outlet and the inlet may be formed at a position higher than a full water level of liquid carbon dioxide stored in the storage tank 10.

The chiller 11 may be provided to cool the storage tank 10. The chiller 11 may liquefy the gaseous carbon dioxide inside the storage tank 10 by cooling the storage tank 10. Through this, the gaseous carbon dioxide recovered from the washing tub 20 and the distillation tub 30 may be liquefied. The liquefied carbon dioxide may be discharged from the storage tank 10 back to the washing tub 20 and used for laundry. The chiller 11 may liquefy the carbon dioxide recovered in a gaseous state so that the carbon dioxide circulates through the storage tank 10, the washing tub 20, and the distillation tub 30. The chiller 11 may include an evaporator of a heat pump. Unlike this, the chiller 11 may include at least one of various types of cooling devices.

The washing tub 20 may provide a space for washing laundry using liquid carbon dioxide as a washing solvent. The washing tub 20 may store liquid carbon dioxide and gaseous carbon dioxide therein. An internal pressure of the washing tub 20 may be maintained at a predetermined pressure or more so that the washing tub 20 may store liquid carbon dioxide therein. The internal pressure of the washing tub 20 may be substantially 30 to 60 bar. A drum 100 may be rotatably disposed inside the washing tub 20.

The washing tub 20 may be disposed in a lower position than the storage tank 10. Accordingly, the liquid carbon dioxide stored in the storage tank 10 may move from the storage tank 10 to the washing tub 20 without power due to gravity.

In a process of putting laundry into the drum 100 inside the washing tub 20, air may be introduced into the washing tub 20. When air is introduced into the washing tub 20, moisture contained in the air may be condensed in a process of lowering the pressure inside the washing tub 20 after washing is completed. In a case in which moisture introduced into laundry is condensed, the laundry may be damaged. In order to prevent this, the washing machine 1 may include a vacuum pump 120 provided to discharge air inside the washing tub 20.

The distillation tub 30 may be provided to accommodate carbon dioxide and foreign substances discharged from the washing tub 20 after washing. Specifically, the distillation tub 30 may accommodate liquid carbon dioxide discharged from the washing tub 20, foreign substances dissolved or not dissolved in the liquid carbon dioxide, and gaseous carbon dioxide therein.

The washing machine 1 may recover the carbon dioxide inside the distillation tub 30 to the storage tank 10. The gaseous carbon dioxide inside the distillation tub 30 may be moved to the storage tank 10 by the compressor 50. The liquid carbon dioxide inside the distillation tub 30 may be vaporized by heat applied to the distillation tub 30. The vaporized carbon dioxide may be moved to the storage tank 10 by the compressor 50. As the liquid carbon dioxide evaporates, foreign substances dissolved in the liquid carbon dioxide may be separated from the liquid carbon dioxide. The foreign substances inside the distillation tub 30 may be discharged into the foreign substance tank 70 after the gaseous carbon dioxide is recovered to the storage tank 10.

In the above process, the gaseous carbon dioxide discharged from the distillation tub 30 becomes a high-temperature and high-pressure gas while passing through the compressor 50. The gaseous carbon dioxide of which temperature has risen by passing through the compressor 50 may supply heat to the inside of the distillation tub 30 by exchanging heat with the distillation tub 30. As heat is generated by the compressor 50 in a process of recovering the carbon dioxide inside the distillation tub 30 to the storage tank 10 and this heat is supplied to the distillation tub 30, the liquid carbon dioxide inside distillation tub 30 may be vaporized. According to an embodiment, heat may be supplied to the distillation tub 30 without including a heat source such as a separate heater.

The foreign substance tank 70 may be provided to store foreign substances discharged from the distillation tub 30. The user may discharge the foreign substances stored in the foreign substance tank 70 at an appropriate emptying cycle. The emptying cycle of the foreign substance tank 70 may vary depending on a capacity of the foreign substance tank 70 and an amount of foreign substances contained in laundry.

The replenishing tank 60 may be provided to replenish carbon dioxide lost in the process of recovering carbon dioxide after washing. The replenishing tank 60 may be provided to store carbon dioxide therein. The replenishing tank 60 may supply carbon dioxide to the washing tub 20. The replenishing tank 60 may be provided to be separable from the washing machine 1. The replenishing tank 60 may be provided to be replaceable with the other replenishing tank 60. Unlike this, the replenishing tank 60 may be provided to be separated from the washing machine 1, filled with carbon dioxide therein, and then be combinable to the washing machine 1 again. A pressure inside the replenishing tank 60 may be set to be higher than the pressure inside the washing tub 20.

Referring to FIG. 1, the washing machine 1 may include a valve provided on a flow path through which carbon dioxide moves. The flow path may include a gas flow path through which gaseous carbon dioxide moves, and a liquid flow path through which liquid carbon dioxide moves. The valve may include a gas valve provided on the gas flow path to open and close the gas flow path through which gaseous carbon dioxide moves. The valve may include a liquid valve provided on the liquid flow path to open and close the liquid flow path through which liquid carbon dioxide moves. The washing machine 1 may include a flow path connection part in which a plurality of flow paths is combined into one flow path or one flow path is branched into a plurality of flow paths.

Although not shown, the washing machine 1 may include a washing tub 20 temperature sensor and a controller 80. The washing tub 20 temperature sensor may be a sensor for detecting a temperature at which condensation begins inside the washing tub 20 and there is a possibility that laundry may be damaged. The temperature at which condensation begins inside the washing tub 20 may be referred to as a first temperature T1.

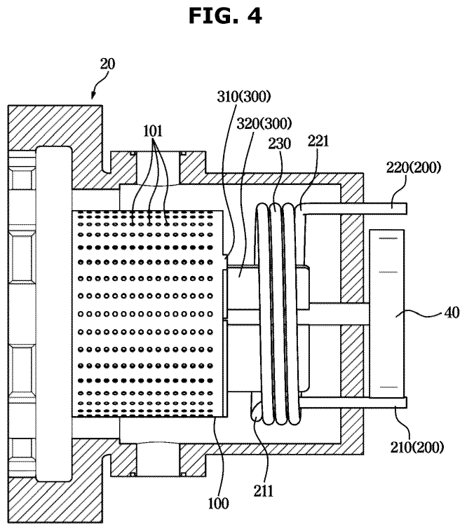

The controller 80 may control to drive the driving device 40 when a value set from the washing tub 20 temperature sensor is equal to or lower than the preset first temperature T1. Specifically, when the compressor 50 is operated to remove carbon dioxide from the washing tub 20 so that the pressure inside the washing tub 20 is reduced, a temperature of the washing tub 20 may gradually decrease. At this time, the driving device 40 may be controlled to operate when the temperature is equal to or lower than the first temperature T1. Air may be circulated inside the washing tub 20 by rotating the drum 100 and a blade 300, which are connected through the driving device 40 and a rotating shaft 110 (see FIG. 4).

However, the condition under which the controller 80 controls the driving device 40 to circulate air in the washing tub 20 is not limited thereto. For example, when a flow path between the washing tub 20 and an input end of the compressor 50 is opened, when the pressure inside the washing tub 20 is equal to or lower than the predetermined pressure, or when a predetermined time elapses after the compressor is operated to reduce the pressure inside the washing tub 20, the controller 80 may control the driving device 40.

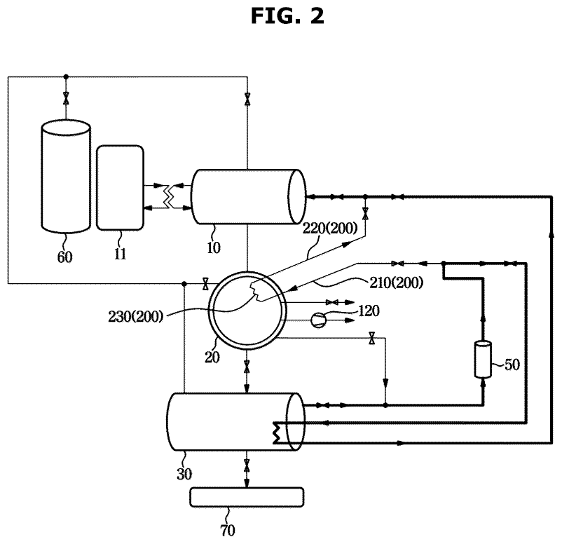

FIG. 2 is a conceptual diagram for explaining the process of recovering carbon dioxide inside the distillation tub 30 to the storage tank 10 in the washing machine 1 according to an embodiment.

Referring to FIG. 2, the washing machine 1 may recover carbon dioxide discharged from the washing tub 20 to the distillation tub 30 to the storage tank 10.

The washing machine 1 may recover gaseous carbon dioxide inside the distillation tub 30 to the storage tank 10, or vaporize liquid carbon dioxide inside the distillation tub 30 and then recover the vaporized carbon dioxide to the storage tank 10.

The washing machine 1 may include a flow path to connect the distillation tub 30 and the input end of the compressor 50 and a valve to open or close the flow path.

Carbon dioxide discharged from the compressor 50 may pass through the inside of the distillation tub 30 or the outside of the distillation tub 30 adjacent to the distillation tub 30. Carbon dioxide contained in a pipe passing through the distillation tub 30 may supply heat to the distillation tub 30.

The distillation tub 30 may discharge foreign substances separated from carbon dioxide into the foreign substance tank 70. Foreign substances separated from carbon dioxide in the distillation tub 30 may be discharged into the foreign substance tank 70 by opening a valve provided between the distillation tub 30 and the foreign substance tank 70.

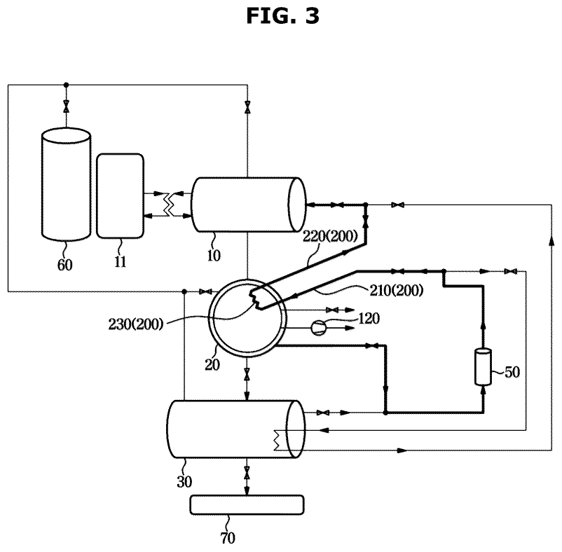

FIG. 3 is a conceptual diagram for explaining a process of recovering carbon dioxide inside the washing tub 20 to the storage tank 10 in the washing machine 1 according to an embodiment.

A depressurizing step for reducing the pressure inside the washing tub 20 in order to withdraw laundry from the washing tub 20 after washing is completed will be described with reference to FIG. 3.

The depressurizing step may refer to lowering the pressure inside the washing tub 20 to 1 to 1.5 bar, which is a level similar to atmospheric pressure. The depressurizing step may be a step of lowering the pressure inside the washing tub 20 by recovering carbon dioxide inside the washing tub 20 to the storage tank 10.

Referring to FIG. 3, the washing machine 1 may be provided with a flow path to connect the washing tub 20 and the input end of the compressor and a valve to be capable of opening and closing the flow path. Carbon dioxide discharged from the compressor 50 may pass through the inside of the washing tub 20 or the outside of the washing tub 20 adjacent to the washing tub 20. Carbon dioxide contained in a washing tub passing pipe 200 passing through the washing tub 20 may supply heat to the washing tub 20.

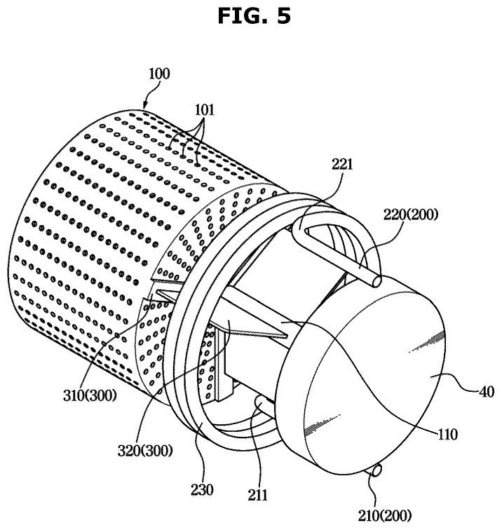

FIG. 4 is a view illustrating a part of the washing machine 1 including the washing tub 20 according to an embodiment of the present disclosure, and FIG. 5 is a perspective view illustrating a part of the washing machine 1 including the blade 300 according to an embodiment of the present disclosure.

Referring to FIG. 4, the washing machine 1 may include the drum 100 provided to be rotatable inside the washing tub 20 and the rotating shaft 110 provided to connect the drum 100 and the drive motor.

The washing tub 20 may contain high-pressure carbon dioxide in a washing process. When the door is opened in a state in which the inside of the washing tub 20 is under a high pressure, due to a pressure difference between the inside and outside of the washing machine 1, the door may be suddenly opened, causing damage to the washing machine 1 or injuring the user.

In order to solve these problems, the inside of the washing tub 20 may be depressurized before taking out the laundry inside the washing tub 20. In a process of depressurizing the inside of the washing tub 20, the temperature inside the washing tub 20 may decrease.

By putting laundry into the washing tub 20, closing the door of the washing tub 20, and operating the vacuum pump 120, the inside of the washing tub 20 may become a state of low pressure close to vacuum. However, the inside of the washing tub 20 is not completely vacuumed, and some air may remain inside the washing tub 20. There is moisture in the air remaining inside the washing tub 20, and this moisture may condense in a process of lowering the pressure inside the washing tub 20. This is because when the pressure inside the washing tub 20 decreases, the temperature inside the washing tub 20 decreases.

When moisture permeated into laundry condenses, the laundry may be damaged. In order to prevent this, it is necessary to keep the temperature inside the washing tub 20 at zero degrees Celsius or more in the depressurizing step. For example, the temperature inside the washing tub 20 may be kept substantially above 10 degrees Celsius. A separate heater may be included to increase the temperature inside the washing tub 20, but because this is not efficient in terms of energy, the washing machine 1 according to the present disclosure may supply heat to the inside of the washing tub 20 using the heat of high-temperature carbon dioxide that has passed through the compressor 50. Specifically, the washing tub passing pipe 200, which is a flow path through which high-temperature carbon dioxide passed through the compressor 50 flows, is provided to pass through the inside or outside of the washing tub 20, thereby supplying heat to the washing tub 20.

Specifically, the washing tub passing pipe 200 may include an inlet pipe 210 forming a flow path through which carbon dioxide discharged from the compressor 50 is introduced into the washing tub 20, and an outlet pipe 220 through which carbon dioxide heat exchanged inside the washing tub 20 is discharged to the outside of the washing tub 20. The washing tub passing pipe 200 may include a heat exchange pipe 230 connecting the inlet pipe 210 and the outlet pipe 220 and capable of exchanging heat with the washing tub 20.

The heat exchange pipe 230 may be connected to the inlet pipe 210 through a first connecting pipe 211 and may be connected to the outlet pipe 220 through a second connecting pipe 221. The first connecting pipe 211 and the second connecting pipe 221 may be formed in a bent shape.

However, the washing tub passing pipe 200 does not necessarily exchange heat with the washing tub 20 only through the heat exchange pipe 230, but may exchange heat with the washing tub 20 through a portion of the inlet pipe 210 included inside the washing tub 20, a portion of the outlet pipe 220, the first connecting pipe 211, and the second connecting pipe 221.

The heat exchange pipe 230 may be formed in a coil shape inside the washing tub 20. Specifically, the heat exchange pipe may be formed to have a plurality of ring-shaped pipes. However, the present disclosure is not limited thereto, and it is sufficient as long as the heat exchange pipe has a configuration capable of securing a sufficient surface area to exchange heat with air inside the washing tub 20.

The washing machine 1 may include the blade 300 protruding from a rear surface of the drum 100. The blade 300 may circulate the air inside the washing tub 20 while rotating by the driving device 40. Specifically, the blade 300 may rotate inside the washing tub 20 and evenly spread the heat emitted from the heat exchange pipe 230 throughout the washing tub 20.

However, the blade 300 does not necessarily need to protrude from the rear surface of the drum 100, and may be configured to protrude radially from the rotating shaft 110 to convect heat into the heat exchange pipe 230.

The blade 300 may be disposed to be provided on an inner side of the heat exchange pipe 230 and correspond to the heat exchange pipe 230. That is, a length from the rear surface of the drum 100 to an end of the blade 300 in a direction in which the rotating shaft 110 extends may be longer than a length from the rear surface of the drum 100 to an end of the heat exchange pipe 230. Specifically, the end of the heat exchange pipe 230 may be a portion of the heat exchange pipe 230 closest to the rear surface of the drum 100. However, the present disclosure is not necessarily limited thereto, and in a case in which the blade 300 does not protrude from the rear surface of the drum 100 and extends radially from the rotating shaft 110, the end of the blade 300 may be disposed farther from the rear surface of the drum 100 than the end of the heat exchange pipe 230. In other words, this may refer to at least a portion of a wing part 320 and at least a portion of the heat exchange pipe 230 being disposed on a plane perpendicular to the rotating shaft 110.

In order to prevent the blade 300 and the heat exchange pipe 230 from colliding when the blade 300 rotates, a portion of the blade 300 disposed to correspond to the heat exchange pipe 230 may have a rotation radius smaller than an inner diameter of the heat exchange pipe 230.

The blade 300 may include a connecting rib 310 protruding from the rear surface of the drum 100 and the wing part 320 protruding from the connecting rib 310 toward a rear surface of the washing tub 20.

The wing part 320 may be disposed such that at least a portion thereof corresponds to the heat exchange pipe 230. Specifically, a rotation radius of the wing part 320 is formed to be smaller than the inner diameter of the heat exchange pipe 230 so that the blade 300 and the washing tub passing pipe 200 may be prevented from colliding when the blade 300 rotates.

That at least a portion of the wing part 320 corresponds to the heat exchange pipe 230 may mean that at least a portion of the wing part 320 and at least a portion of the heat exchange pipe 230 are disposed on a plane perpendicular to the rotating shaft 110.

The wing part 320 may be formed in a plate shape to increase an amount of air circulated by expanding a surface area in contact with air when the blade 300 rotates.

Because the wing part 320 receives great air resistance when the blade 300 rotates, there is a risk of damage as the blade 300 rotates strongly or continues.

In order to prevent this, a thickness of the connecting rib 310 may be formed to be thicker than a thickness of the wing part 320. Also, a length of the connecting rib 310 radially extending from the rotating shaft 110 may be longer than a length of the blade 300. The length of the connecting rib 310 may be formed to be substantially equal to a radius of the drum 100.

The washing machine 1 may include a reinforcing rib (not shown) provided separately from the connecting rib 310. Although not shown, the reinforcing rib protrudes from the rear surface of the drum 100 or is connected to the rear surface of the drum 100 to ensure a strength of the drum 100 so that a part of the drum 100 may be not damaged when the drum 100 rotates. Additionally, the reinforcing rib may efficiently transmit a rotational force of the driving device 40 to the drum 100.

Referring to FIG. 5, the drum 100 and the blade 300 may be connected to the driving device 40 through the rotating shaft 110. As the driving device 40 rotates, the drum 100 and the blade 300 may also rotate.

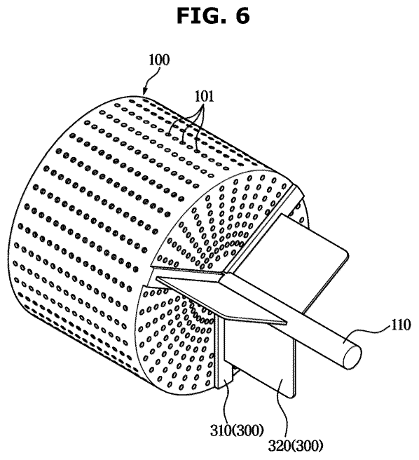

FIGS. 6 to 9 are perspective views illustrating parts of the washing machine 1 including the blade 300 according to an embodiment of the present disclosure.

Referring to FIG. 6, the length of the wing part 320 radially extending may be shorter than the length of the connecting rib 310. A length of the wing part 320 in a direction in which the rotating shaft 110 extends may be formed to be sufficiently long to correspond to the washing tub passing pipe 200 when the drum 100 and the blade 300 are included inside the washing tub 20. In addition, the thickness of the connecting rib 310 in a direction perpendicular to the radial direction of the connecting rib 310 may be formed to be thicker than the thickness of the wing part 320 so that the connecting rib 310 may support the wing part 320. However, the blade 300 of the present disclosure is not necessarily limited thereto, and the connecting rib 310 and the wing part 320 may be formed to have the same thickness, width, or length, and the blade 300 may be formed to be spaced apart from the drum 100.

When rotating, the blade 300 may collide with the heat exchange pipe 230. Therefore, a diameter of the wing part 320 centered around the rotating shaft 110 may be smaller than the inner diameter of the heat exchange pipe 230 centered around the rotating shaft 110.

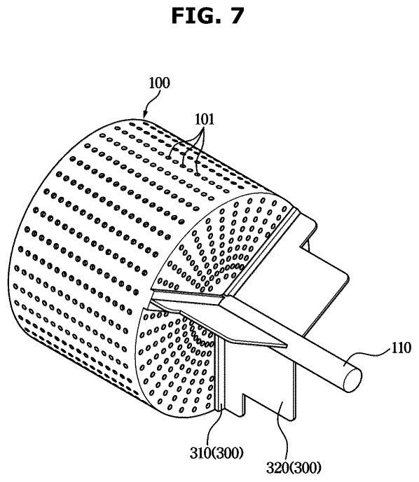

Referring to FIG. 7, the wing part 320 may include portions with different lengths extending radially from the rotating shaft. In other words, the wing part 320 may include portions with different diameters centered around the rotating shaft 110.

Due to this, when the blade 300 rotates, a portion of the blade 300 and the heat exchange pipe 230 may be prevented from colliding.

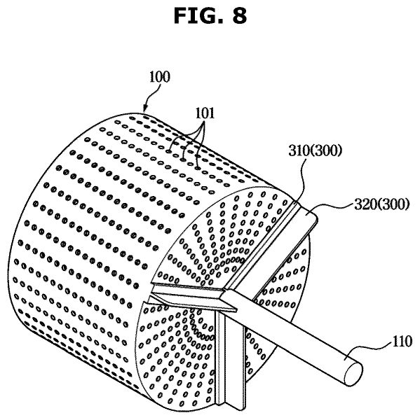

Referring to FIG. 8, the lengths of the connecting rib 310 and the wing part 320 extending radially from the rotating shaft 110 may be the same.

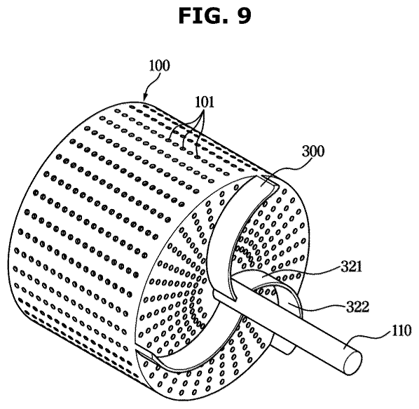

Referring to FIG. 9, the blade 300 may be formed in a spiral shape. Specifically, the blade may not extend radially from the rotating shaft 110 in one straight direction but may extend to form a curved surface. Accordingly, as illustrated in FIG. 9, the blade 300 may include a convex surface 321 and a concave surface 322.

When the blade 300 rotates in a direction from the convex surface 321 to the concave surface 322, the blade may receive great air resistance. Therefore, a main rotation direction of the blade 300 may be a direction from the convex surface 321 to the concave surface 322.

However, because when the blade rotates in only one direction, laundry may be concentrated on one side, or heat or carbon dioxide may be concentrated in one area, the blade 300 does not necessarily have to rotate only in the direction from the convex surface 321 to the concave surface 322, and may rotate in the opposite direction as well.

A washing machine 1 according to an embodiment of the present disclosure includes a storage tank 10 provided to store carbon dioxide, a washing tub 20 provided to wash laundry using the carbon dioxide, a distillation tub 30 provided to separate the carbon dioxide discharged from the washing tub 20 and foreign substances contained in the carbon dioxide, a compressor 50 provided to compress the carbon dioxide discharged from the washing tub 20, a drum 100 rotatably provided inside the washing tub 20, a driving device 40 provided to rotationally drive the drum 100 around a rotating shaft 110, a washing tub passing pipe 200 provided to pass through the inside of the washing tub 20 to transfer heat of the carbon dioxide compressed from the compressor 50 to the washing tub 20, and a blade 300 provided to protrude radially from the rotating shaft 110 to rotate by receiving power from the driving device 40. According to the present disclosure, damage to laundry may be prevented by preventing an internal temperature of the washing tub 20 from rapidly dropping when a pressure of the washing tub 20 is reduced.

The blade 300 may be disposed such that at least a portion of the blade 300 corresponds to the washing tub passing pipe 200 inside the washing tub 20 to facilitate heat exchange between the washing tub 20 and the washing tub passing pipe 200.

The washing tub passing pipe 200 may include an inlet pipe 210 connected to a flow path extending from the compressor 50, an outlet pipe 220 connected to the storage tank 10, and a heat exchange pipe 230 connected to the inlet pipe 210 and the outlet pipe 220 and extending in a coil shape at a predetermined distance from an inner circumferential surface of the washing tub 20.

The blade 300 may be disposed such that at least a portion of the blade 300 is farther from a rear surface of the drum 100 than an end of the heat exchange pipe 230.

The blade 300 may include a wing part 320, and a connecting rib 310 protruding from the rear surface of the drum 100 to be connected to the wing part 320.

A length of the connecting rib 310 extending in a direction perpendicular to the rotating shaft 110 may be longer than a length of the wing part 320 extending in the direction perpendicular to the rotating shaft 110.

The blade 300 may include a concave surface 322 and a convex surface 321 formed on an opposite side of the concave surface 322.

The washing machine may further include a controller 80 configured to control rotation of the driving device 40, and a washing tub temperature sensor 90 provided to measure a temperature inside the washing tub 20, wherein the controller 80 may control the driving device 40 to rotate the blade 300 when the carbon dioxide is discharged from the washing tub 20 to the compressor 50.

The controller 80 may control the driving device 40 to rotate the blade 300 when a temperature detected by the washing tub temperature sensor 90 is equal to or lower than a preset first temperature T1.

The washing tub passing pipe 200 may further include a first connecting pipe 211 formed in a bent shape to connect the inlet pipe 210 and the heat exchange pipe 230, and a second connecting pipe 221 formed in a bent shape to connect the outlet pipe 220 and the heat exchange pipe 230.

The drum 100 may include a plurality of passing holes 101 at the rear surface of the drum 100.

A rotation radius of the wing part 320 may be smaller than an inner diameter of the heat exchange pipe 230 centered on the rotating shaft 110.

A thickness of the connecting rib 310 may be thicker than a thickness of the wing part 320.

A washing machine 1 according to an embodiment of the present disclosure includes a storage tank 10 provided to store carbon dioxide, a washing tub 20 provided to wash laundry using the carbon dioxide, a compressor 50 provided to compress the carbon dioxide discharged from the washing tub 20, a drum 100 rotatably provided inside the washing tub 20, a driving device 40 provided to rotationally drive the drum 100 around a rotating shaft 110, an inlet pipe 210 connected to a flow path discharged from the compressor 50, an outlet pipe 220 connected to the storage tank 10, a washing tub passing pipe 200 including a heat exchange pipe 230 connected to the inlet pipe 210 and the outlet pipe 220 and extending in a coil shape at a predetermined distance from an inner circumferential surface of the washing tub 20, and a blade 300 provided to protrude radially from the rotating shaft 110 to rotate by receiving power from the driving device 40. According to the present disclosure, damage to laundry may be prevented by preventing an internal temperature of the washing tub 20 from rapidly dropping when a pressure of the washing tub 20 is reduced while the carbon dioxide passed through the compressor 50 exchanges heat with the washing tub 20 through the washing tub passing pipe 200.

The blade 300 may be disposed such that at least a portion of the blade 300 corresponds to the washing tub passing pipe 200 inside the washing tub 20 to facilitate heat exchange between the washing tub 20 and the washing tub passing pipe 200.

A length of the blade 300 in a direction in which the rotating shaft 110 extends may be longer than a distance between a rear surface of the drum 100 and an end of the heat exchange pipe 230.

The blade 300 may include a wing part 320, and a connecting rib 310 protruding from the rear surface of the drum 100 to be connected to the wing part 320.

The washing machine may further include a controller 80 configured to control rotation of the driving device 40, and a washing tub temperature sensor 90 provided to measure a temperature inside the washing tub 20, and the controller 80 may control the driving device 40 to rotate the blade 300 when a temperature detected by the washing tub temperature sensor 90 is equal to or lower than a preset first temperature.

Effects obtainable from the present disclosure are not limited to the effects mentioned above, and other effects not mentioned will be clearly understood by those skilled in the art from the description below.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A washing machine comprising:
a storage tank configured to store carbon dioxide;
a washing tub configured to wash laundry using the carbon dioxide;
a distillation tub configured to separate the carbon dioxide discharged from the washing tub and foreign substances contained in the carbon dioxide;
a compressor configured to compress the carbon dioxide discharged from the washing tub and move the compressed carbon dioxide to the storage tank;
a rotatable drum inside the washing tub;
a driving device configured to drive rotation of a rotatable shaft connected to the rotatable drum to rotate the rotatable drum;
a washing tub passing pipe configured to pass through an inside of the washing tub to exchange heat of the compressed carbon dioxide with the washing tub; and
a blade protruding radially from the rotatable shaft so that the blade is rotated by rotation of the rotatable shaft to circulate air inside the washing tub to spread the heat of the compressed carbon dioxide emitted from the washing tub passing pipe.

2. The washing machine according to claim 1, wherein
at least a portion of the blade corresponds to the washing tub passing pipe along an inside of the washing tub to facilitate heat exchange between the washing tub and the washing tub passing pipe.

3. The washing machine according to claim 2, wherein
the washing tub passing pipe includes:
an inlet pipe connected to a flow path extending from the compressor,
an outlet pipe connected to the storage tank, and
a heat exchange pipe connected to the inlet pipe and the outlet pipe and extending in a coil shape a distance from an inner circumferential surface of the washing tub.

4. The washing machine according to claim 3, wherein
at least a portion of the blade extends farther from a rear surface of the rotatable drum than the heat exchange pipe so that at least the portion of the blade is farther from the rear surface than an end of the heat exchange pipe which is connected to the inlet pipe or the outlet pipe.

5. The washing machine according to claim 3, wherein
the blade includes a wing part, and
a connecting rib, protruding from a rear surface of the rotatable drum, and connected to the wing part.

6. The washing machine according to claim 5, wherein
a length of the connecting rib extending in a direction perpendicular to the rotatable shaft is longer than a length of the wing part extending in the direction perpendicular to the rotatable shaft.

7. The washing machine according to claim 1, wherein
the blade includes a concave surface and a convex surface on an opposite side of the blade from the concave surface.

8. The washing machine according to claim 6, further comprising:
a controller configured to control rotation of the driving device, wherein the controller is configured to control the driving device to rotate the blade when carbon dioxide is discharged from the washing tub to the compressor.

9. The washing machine according to claim 8, further comprising:
a washing tub temperature sensor configured to measure a temperature inside the washing tub,
wherein the controller is configured to control the driving device to rotate the blade when the temperature inside the washing tub detected by the washing tub temperature sensor is equal to or lower than a first temperature.

10. The washing machine according to claim 3, wherein
the washing tub passing pipe further includes a first connecting pipe in a bent shape to connect the inlet pipe and the heat exchange pipe, and a second connecting pipe in a bent shape to connect the outlet pipe and the heat exchange pipe.

11. The washing machine according to claim 3, wherein
the rotatable drum includes a plurality of passing holes at a rear surface of the rotatable drum.

12. The washing machine according to claim 5, wherein
a rotation radius of the wing part from the rotatable shaft is smaller than an inner radius of the heat exchange pipe from the rotatable shaft so as to prevent collision between the wing part and the heat exchange pipe when the blade is rotated by the rotatable shaft.

13. The washing machine according to claim 12, wherein
a thickness of the connecting rib is greater than a thickness of the wing part.
